(19) United States
(12) Patent Application Publication
(10) Pub. No.: US 2007/0046194 A1
(43) Pub. Date: Mar. 1, 2007

(54) Plasma display panel

(76) Inventor: Ho-Seok Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/511,234

(22) Filed: Aug. 29, 2006

(30) Foreign Application Priority Data
Aug. 29, 2005 (KR) 10-2005-0079226

(51) Int. Cl. H01J 1/62

(52) U.S. Cl. 313/506

(57) ABSTRACT

A plasma display panel that may reduce an external light reflection ratio and improve a bright room contrast includes first and second substrates parallel to each other, a plurality of sustain electrodes disposed on the first substrate and a plurality of main electrode portions, a first dielectric layer covering the sustain electrodes, barrier ribs interposed between the first and the second substrates and partitioning discharge cells along with the sustain electrodes, address electrodes disposed on the second substrate and crossing the sustain electrodes, a second dielectric layer covering the address electrodes, luminescent layers disposed in the discharge cells, and a discharge gas in the discharge cells, in which the main electrode portions may include first electrode layers and second electrode layers which may be adhered to the first electrode layers, and the second electrode layers having widths less than or equal to widths of the first electrode layers.

### BACKGROUND OF THE INVENTION

1. Field of the Invention

The present invention relates to a plasma display panel (PDP). More particularly, the present invention relates to a PDP that may include sustain electrodes that may reduce reflection of external light and may improve bright room contrast.

2. Description of the Related Art

Plasma display panels (PDPs) may be flat display devices which may form images by exciting, for example, a phosphor material using ultraviolet (UV) rays generated from a gas discharge. PDPs may be considered as the next generation display device due to their slim, large and high resolution screens.

Generally, PDPs may include a front substrate disposed on a user side and a rear substrate disposed on a back side, a plurality of discharge electrodes interposed between the two substrates, and barrier ribs.

The discharge electrodes and the barrier ribs may partition discharge cells. Luminescent layers, such as phosphor layers, may be formed by disposing phosphor materials that may emit red, green, or blue visible light in the discharge cells. Also, the discharge cells may be filled with a discharge gas, such as neon (Ne) or xenon (Xe), after the front and rear substrates are sealed.

In an exemplary operation, a predetermined voltage may be applied to the discharge electrodes to drive a PDP and cause a discharge. UV rays may be generated from the gas discharge, which may excite the phosphor layers in the discharge cells and may emit visible light due to reduction of the energy level of the phosphor layers.

However, PDPs may use discharge electrodes formed of transparent indium tin oxide (ITO) which may be expensive and may require a complex manufacturing process. These discharge electrodes may also be short-circuited during the manufacturing process.

Further, PDPs, which may use the discharge electrodes formed of transparent ITO, may receive external visible light via the front substrate and discharge electrodes. This external visible light may also reach the rear substrate and the barrier ribs and reflect back to the discharge electrodes and front substrate. In this regard, an external light reflection ratio is increased, and bright room contrast of the PDPs is reduced.

Therefore, it is necessary to develop a PDP including discharge electrodes not formed of transparent ITO that may improve a bright room contrast by reducing an external light reflection ratio of the discharge electrodes.

### SUMMARY OF THE INVENTION

The present invention is therefore directed to a plasma display panel, which substantially overcomes one or more of the problems due to the limitations and disadvantages of the related art.

It is therefore a feature of an embodiment of the present invention to provide a plasma display panel, which may reduce an external light reflection ratio and improve bright room contrast.

At least one of the above and other features and advantages of the present invention may be realized by providing a plasma display panel having a first substrate, a second substrate parallel to the first substrate, a plurality of sustain electrodes disposed on the first substrate, each sustain electrode including a plurality of main electrode portions, a first dielectric layer covering the sustain electrodes, barrier ribs interposed between the first and the second substrates to partition discharge cells along with the sustain electrodes, address electrodes disposed on the second substrate and cross the sustain electrodes, a second dielectric layer covering the address electrodes, luminescent layers disposed in the discharge cells, and a discharge gas in the discharge cells, the main electrode portions including first electrode layers adhered to the first substrate and second electrode layers adhered to the first electrode layers, the second electrode layers having widths less than or equal to widths of the first electrode layers.

The main electrode portions may be substantially parallel to one another.

The sustain electrodes may further include a connection electrode portion which connects the main electrode portions. The connection electrode portion may perpendicularly intersect the main electrode portions.

The connection electrode portion may include a plurality of connection electrode portions.

Each of the discharge cells may include at least two connection electrode portions.

The connection electrode portions may include a third electrode layer which may be adhered to the first substrate and a fourth electrode layer which may be adhered to the third electrode layer and may have a width less than or equal to a width of the third electrode layer.

The third electrode layer may be formed of a metal oxide. The metal oxide may have a color for absorbing light. The color for absorbing the light may be black.

The fourth electrode layer may be formed of a conductive metal including silver (Ag) or aluminum (Al).

Each of the sustain electrodes may include a common electrode and a scan electrode disposed parallel to each other.

The barrier ribs may be formed of dielectric materials.

At least a portion of the first dielectric layer may be covered by a protective layer.

The first electrode layers may be formed of a metal oxide. The metal oxide may have a color for absorbing light. The color for absorbing the light may be black.

The second electrode layer may be formed of a conductive metal including silver (Ag) or aluminum (Al).

At least one of the above and other features and advantages of the present invention may be realized by providing a plasma display panel having a first substrate and a second substrate, a plurality of sustain electrodes disposed on the first substrate, each sustain electrode including a plurality of main electrode portions, and barrier ribs arranged between the first and second substrates to define a plurality of discharge cells, each main electrode portion including first electrode layers and second electrode layers, the second electrode layers having widths less than or equal to widths of the first electrode layers, and sustain electrodes made of a black metal oxide.

At least one of the above and other features and advantages of the present invention may be realized by providing a plasma display panel having a first substrate and a second substrate, a plurality of sustain electrodes disposed on the first substrate, each sustain electrode having a plurality of main electrode portions and a plurality of connection electrode portions connecting the main electrode portions, and barrier ribs arranged between the first and second substrates to define a plurality of discharge cells, each main electrode portion having first electrode layers and second electrode layers, second electrode layers having widths less than or equal to widths of the first electrode layers, and sustain electrodes made of a black metal oxide.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a partial cut-away perspective view of a plasma display panel (PDP) according to an exemplary embodiment of the present invention;

FIG. 2 illustrates a partial perspective view of sustain electrodes in the PDP illustrated in FIG. 1 according to an exemplary embodiment of the present invention;

FIG. 3 illustrates a cross-sectional view of sustain electrodes taken along line III-III in FIG. 2 according to an exemplary embodiment of the present invention;

FIG. 4 illustrates a cross-sectional view of the sustain electrodes taken along line IV-IV in FIG. 2 according to an exemplary embodiment of the present invention;

FIG. 5 illustrates a schematic partial cross-sectional view of the PDP of FIG. 1, and illustrates paths along which external light may be reflected and absorbed by the PDP;

FIG. 6 illustrates a cross-sectional view of main electrode portions of a modified PDP according to an exemplary embodiment of the present invention; and

FIG. 7 illustrates a cross-sectional view of connection electrode portions of the modified PDP according to an exemplary embodiment of the present invention.

### DETAILED DESCRIPTION OF THE INVENTION

Korean Patent Application No.10-2005-0079226, filed on Aug. 29, 2005, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions may be exaggerated for clarity of illustration. It will also be understood that when a layer is referred to as being “on” another layer or substrate, it may be directly on the other layer or substrate, or intervening layers may also be present. Further, it will be understood that when a layer is referred to as being “under” another layer, it may be directly under, or one or more intervening layers may also be present. In addition, it will also be understood that when a layer is referred to as being “between” two layers, it may be the only layer between the two layers, or one or more intervening layers may also be present. Like reference numerals refer to like elements throughout.

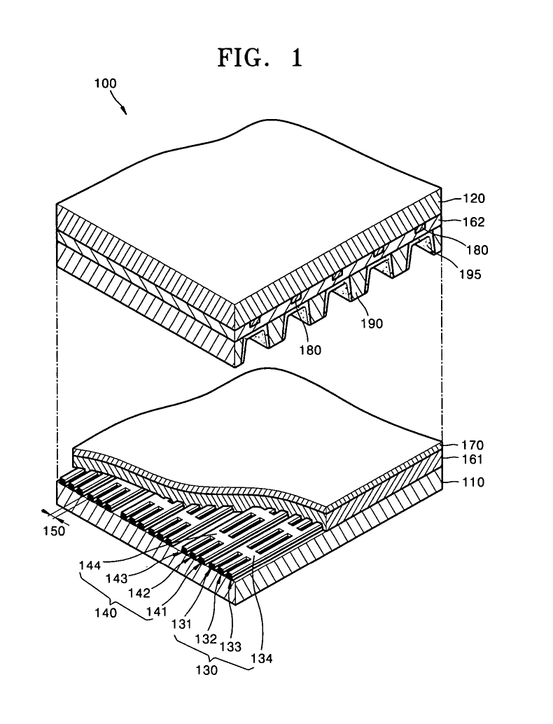

FIG. 1 illustrates a partial cut-away perspective view of a plasma display panel (PDP) 100 according to an exemplary embodiment of the present invention. Referring to FIG. 1, the PDP 100 may be an alternating current (AC) surface discharge type PDP, and may include a transparent first substrate 110 and a second substrate 120 parallel to and spaced apart from the first substrate 110 by a predetermined distance.

The first substrate 110 may be, for example, transparent so that visible light generated by a discharge may be transmitted through the first substrate 110. However, the present invention is not limited thereto. That is, the first substrate 110 may be, for example, opaque and the second substrate 120 may be, for example, transparent or both first substrate 110 and second substrate 120 may be transparent. Also, the first and second substrates 110 and 120 may be semi-transparent and have a color filter.

A pair of sustain electrodes 130 and 140 which may be considered discharge electrodes may be formed on the first substrate 110 with a discharge gap 150 between them.

One of the sustain electrodes 130 and 140 may serve as a scan electrode and the other electrode may serve as a common electrode. The sustain electrode 130 may include, for example, three main electrode portions 131, 132, and 133 and a connection electrode portion 134 that may connect the main electrode portions 131, 132, and 133. Likewise, the sustain electrode 140 may include, for example, three main electrode portions 141, 142, and 143 and a connection electrode portion 144 that may connect the main electrode portions 141, 142, and 143.

The main electrode portions 131, 132, 133, 141, 142, and 143 may be parallel to one another. The connection electrode portions 134 and 144 may perpendicularly intersect the main electrode portions 131, 132, 133, 141, 142, and 143, and may electrically connect the main electrode portions 131, 132, 133, 141, 142, and 143 of the sustain electrodes 130 and 140, respectively.

While the sustain electrodes 130 and 140 may each include three main electrode portions 131, 132, 133, and 141, 142, and 143, respectively, and the main electrode portions 131, 132, 133, and 141, 142, and 143 may be parallel to one another, the present invention is not limited thereto. That is, the number of the main electrode portions of the sustain electrodes 130 and 140 may vary provided the main electrode portions 131, 132, 133, 141, 142, and 143 can generate a discharge and secure a sufficient opening ratio to maintain reflection brightness. Hence, the number of the main electrode portions of the sustain electrodes 130 and 140 may be, for example, two, four, or more, respectively. Also, the main electrode portions of the sustain electrodes 130 and 140 are not limited to being parallel to one another, and may be, for example, serpentine-shaped or partly concave-shaped with a regular discharge gap between them, provided they can generate a discharge.

While the connection electrode portions 134 and 144 may perpendicularly intersect the main electrode portions 131, 132, 133, 141, 142, and 143, and electrically connect the main electrode portions 131, 132, 133, 141, 142, and 143, the present invention is not limited thereto. That is, the connection electrode portions 134 and 144 may intersect the main electrode portions 131, 132, 133, 141, 142, and 143, for example, at any angle provided they can electrically connect the main electrode portions 131, 132, 133, 141, 142, and 143.

Further, while the sustain electrodes 130 and 140 may include the connection electrode portions 134 and 144, the present invention is not limited thereto. That is, the sustain electrodes 130 and 140 may not include the connection electrode portions 134 and 144 and may only include, for example, the main electrode portions 131, 132, 133, 141, 142, and 143. However, the sustain electrodes 130 and 140 may include the connection electrode portions 134 and 144, for example, to prevent the main electrode portions 131, 132, 133, 141, 142, and 143 from being short-circuited.

The sustain electrodes 130 and 140 may be buried in or covered by a first dielectric layer 161. The first dielectric layer 161 may prevent the sustain electrodes 130 and 140 from directly sending current when a sustain discharge is generated. The first dielectric layer 161 may also prevent the sustain electrodes 130 and 140 from becoming damaged by charged particles colliding with the sustain electrodes 130 and 140. The first dielectric layer 161 may induce the charged particles to accumulate wall charges. The first dielectric layer 161 may be composed of dielectric materials such as PbO, B₂O₃, SiO₂ or the like.

A protective layer 170 may be formed of a material such as MgO or the like. The protective layer 170 may be formed on the first dielectric layer 161. The protective layer 170 may prevent the sustain electrodes 130 and 140 from being damaged due to sputtering of plasma particles. The protective layer also may emit secondary electrons and reduce a discharge voltage.

Address electrodes 180 may be formed on the second substrate 120 and intersect the sustain electrodes 130 and 140. The address electrodes 180 may perform an address discharge along with a discharge electrode serving as a scan electrode in the sustain electrodes 130 and 140. A second dielectric layer 162 may bury the address electrodes 180 and may protect the address electrodes 180.

Barrier ribs 190 may be formed of dielectric materials and may be formed on a surface of the second dielectric layer 162. The barrier ribs 190 may maintain a discharge distance and may prevent electrical and optical cross-talk between discharge cells. The barrier ribs 190 may be formed in an open shape of a stripe pattern but the present invention is not limited thereto. That is, the barrier ribs 190 may be formed, for example, in a closed shape, such as an oval, circle, or polygon such as a rectangle, a triangle, a pentagon, etc. The barrier ribs 190, the sustain electrodes 130 and 140, and the address electrodes 180 may form a discharge space, which may be called a discharge cell per unit, forming a pixel.

The discharge cell per unit may include at least one of each of the connection electrode portions 134 and 144. In this regard, the current among the main electrode portions 131, 132, 133, 141, 142, and 143 may flow more easily, and the sustain discharge and address discharge may be performed, which may prevent the main electrode portions 131, 132, 133, 141, 142, and 143 from short-circuiting.

A luminescent layer, such as phosphor layers 195 may be formed by coating red, green, and blue light emitting phosphor materials on a bottom surface of the second dielectric layer 162 and both sides of the barrier ribs 190. The phosphor layers 195 may have a component generating a visible light with ultraviolet rays. That is, a phosphor layer may be formed in a red light emitting discharge cell that may have, for example, a phosphor, such as Y(V,P)O₄:Eu, a phosphor layer may be formed in a green light emitting discharge cell that may have, for example, a phosphor such as Zn₂SiO₄:Mn, and a phosphor layer may be formed in a blue light emitting discharge cell that may have, for example, a phosphor such as BAM:Eu.

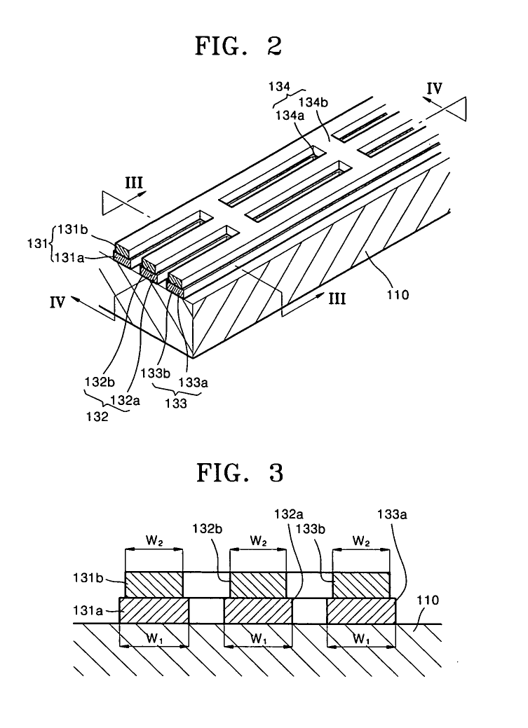

FIG. 2 illustrates a partial perspective view of the sustain electrodes 130 in the PDP illustrated in FIG. 1 according to an exemplary embodiment of the present invention. Referring to FIG. 2, the main electrode portions 131, 132, and 133, and the connection electrode portion 134 may be formed of two layers. More specifically, each of the main electrode portions 131, 132, and 133 may be formed of first electrode layers 131a, 132a, and 133a and second electrode layers 131b, 132b, and 133b. The connection electrode portion 134 may be formed of a third electrode layer 134a and a fourth electrode layer 134b.

The first electrode layers 131a, 132a, and 133a and the third electrode layer 134a may be tightly adhered to the first substrate 110. The second electrode layers 131b, 132b, and 133b, and the fourth electrode layer 134b may be tightly adhered to the first electrode layers 131a, 132a, and 133a and the third electrode layer 134a, respectively.

The widths of the first electrode layers 131a, 132a, and 133a may be greater than those of the second electrode layers 131b, 132b, and 133b, respectively. However, the present invention is not limited thereto. That is, the widths of the first electrode layers 131a, 132a, and 133a may be the same as the widths of the second electrode layers 131b, 132b, and 133b, respectively.

The width of the third electrode layer 134a may be greater than that of the fourth electrode layer 134b. However, the present invention is not limited thereto. That is, the width of the third electrode layer 134a may be the same as the width of the of the fourth electrode layer 134b.

FIG. 3 illustrates a cross-sectional view of the sustain electrodes 130 taken along line III-III in FIG. 2 according to an exemplary embodiment of the present invention.

Referring to FIG. 3, widths W₁ of the first electrode layers 131a, 132a, and 133a may be greater than widths W₂ of the second electrode layers 131b, 132b, and 133b, respectively. Also, the widths W₁ of the first electrode layers 131a, 132a, and 133a of the main electrode portions 131, 132, and 133 may be the same but the present invention is not limited thereto. That is, the widths of the first electrode layers 131a, 1 32a, and 133a may be different from one another. Additionally, the widths W₁ of the first electrode layers 131a, 132a, and 133a may be the same as the widths W₂ of the second electrode layers 131b, 132b, and 133b, respectively.

The widths W₂ of the second electrode layers 131b, 132b, and 133b of the main electrode portions 131, 132, and 133 may be the same but the present invention is not limited thereto. That is, the widths of the second electrode layers 131b, 132b, and 133b may be different from one another.

Additionally, the widths W₂ of the second electrode layers 131b, 132b, and 133b may be less than the widths W₁ of the first electrode layers 131a, 132a, and 133a, respectively.

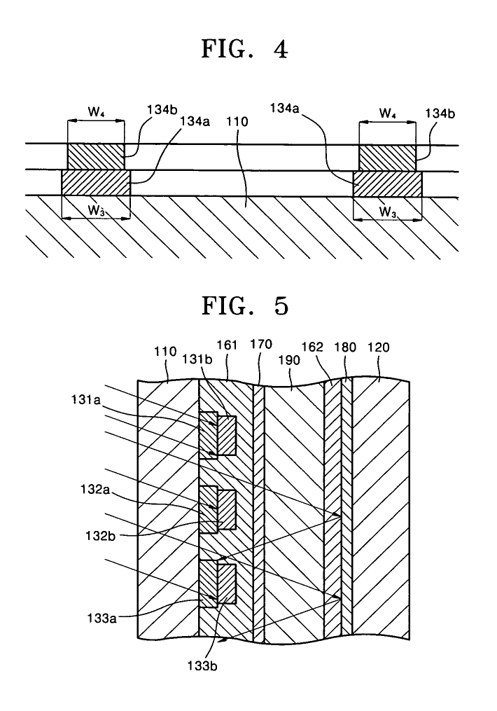

FIG. 4 illustrates a cross-sectional view of the sustain electrodes 130 taken along line IV-IV in FIG. 2 according to an exemplary embodiment of the present invention.

Referring to FIG. 4, a width W₃ of the third electrode layer 134a may be greater than a width W₄ of the fourth electrode layer 134b. The widths W₃ and W₄ of the third electrode layer 134a and the fourth electrode layer 134b, respectively, of the connection electrode portion 134, may be constant along the entire length of the third electrode layer 134a and the fourth electrode layer 134b, respectively. However, the present invention is not limited thereto. That is, the widths W₃ and W₄ of the third electrode layer 134a and the fourth electrode layer 134b may not be constant along the entire length of the third electrode layer 134a and the fourth electrode layer 134b, respectively. Additionally, the width W₃ of the third electrode layer 134a may be equal to the width W₄ of the fourth electrode layer 134b.

59 The first electrode layers 131a, 132a, and 133a and the third electrode layer 134a may be formed of black metal oxide having high external light absorption. For example, metal oxide such as PbO, SiO₂, Al₂O₃, B₂O₃, etc., binder resin, and colorful materials such as Cr, Cu, Fe, etc. may be mixed to form a paste and then the first electrode layers 131a, 132a, and 133a and the third electrode layer 134a may be formed by disposing the paste on the first substrate 110. However, the first electrode layers 131a, 132a, and 133a and the third electrode layer 134a of the present invention are not limited thereto. That is, the first electrode layers 131a, 132a, and 133a and the third electrode layer 134a may be formed of other materials with sufficient blackness to absorb external light. Additionally, while the first electrode layers 131a, 132a, and 133a and the third electrode layer 134a may be formed of, for example, non-conductive materials, the present invention is not limited thereto. That is, the first electrode layers 131a, 132a, and 133a and the third electrode layer 134a may be formed of, for example, conductive materials.

The second electrode layers 131b, 132b, and 133b and the fourth electrode layer 134b may be formed of, for example, silver (Ag). For example, materials such as Ag, PbO, binder resin, etc. may be mixed to form a paste and then the second electrode layers 131b, 132b, and 133b, and the fourth electrode layer 134b may be formed by disposing the paste on the first electrode layers 131a, 132a, and 133a and the third electrode layer 134a, respectively. The second electrode layers 131b, 132b, and 133b, and the fourth electrode layer 134b, may have conductive properties. However, the second electrode layers 131b, 132b, and 133b, and the fourth electrode layer 134b of the present invention are not limited thereto. That is, the second electrode layers 131b, 132b, and 133b, and the fourth electrode layer 134b may be formed of, for example, colorful conductive metal, for example, aluminum (Al).

The first electrode layers 131a, 1312a, 133a, the second electrode layers 131b, 132b, 133b, the third electrode layer 134a, and the fourth electrode layer 134b illustrated in FIG. 2 may be included in the sustain electrode 130. Likewise, the main electrode portions 141, 142, and 143 and the connection electrode 144 of the sustain electrode 140 may include first, second, third, and fourth electrode layers.

The PDP 100 may be filled with air after the first and second substrates 110 and 120 are tightly sealed. However, the air may be replaced with a discharge gas by completely exhausting the air to increase discharge efficiency. The discharge gas may be a mixed gas such as Ne—Xe, He—Xe, He—NE-Xe, etc.

An exemplary discharge process performed by the PDP 100 according to an exemplary embodiment of the present invention will now be described.

A predetermined address voltage may be applied from an external power source between the address electrodes 180 and one of the sustain electrodes 130 and 140 serving as a scan electrode, so that an address discharge may occur and a discharge cell in which a sustain discharge occurs may be selected. A discharge sustain voltage may be applied between the sustain electrodes 130 and 140 of the selected discharge cell, so that the first dielectric layer 161 may be charged with wall charges using the sustain electrodes 130 and 140, the wall charges may move, and the sustain discharge may occur.

A discharge may be performed between the main electrode portions 131 and 141 near the discharge gap 150 among the main electrode portions of the sustain electrodes 130 and 140. The discharge may extend to the other main electrode portions 132,133, 142, and 143, and the sustain discharge may occur as a whole.

After the sustain discharge, an energy level of the discharge gas excited by the sustain discharge may be lowered and UV rays may be emitted. The UV rays may excite luminescent materials, such as phosphor materials of the phosphor layers 195 disposed in the discharge cells. The energy level of the excited phosphor materials may be lowered and visible light may be emitted. The emitted visible light may be projected onto the first substrate 110, which may form an image recognizable by a user.

The exemplary PDP 100 may operate in a bright place, since the first electrode layers 131a, 132a, and 133a and the third electrode layer 134a of the sustain electrodes 130 may be formed of black metal oxide, and the widths of the first electrode layers 131a, 132a, and 133a and the third electrode layer 134a may be greater than the widths of the second electrode layers 131b, 132b, and 133b and the fourth electrode layer 134b, respectively. Thus, the first electrode layers 131a, 132a, and 133a and the third electrode layer 134a may absorb most of the external light entering from outside of the PDP 100.

FIG. 5 illustrates a schematic partial cross-sectional view of the PDP 100 of FIG. 1, and illustrates paths along which external light may be reflected and absorbed by the PDP 100.

Referring to FIG. 5, some of the external light indicated by arrows entering through the first substrate 110 may be absorbed by the first electrode layers 131a, 132a, and 133a and the third electrode layer 134a. Other external light that may not be absorbed by the first electrode layers 131a, 132a, and 133a and the third electrode layer 134a may propagate through the first dielectric layer 161 and the protective layer 170 and be reflected onto the barrier ribs 190, the second dielectric layer 162, and the address electrodes 180. Some of the reflected external light may be absorbed by the first electrode layers 131a, 132a, and 133a and the third electrode layer 134a, and the other reflected external light may be transmitted through the first substrate 110 to the outside of the PDP 100.

The first electrode layers 131a, 132a, and 133a and the third electrode layer 134a may considerably absorb the externally light so that the reflection of the external light may be greatly reduced, which may improve a bright room contrast of an image displayed on the PDP 100.

According to the exemplary PDP 100 of the present invention, the sustain electrodes 130 and 140 may not be formed of ITO, the first electrode layers 131a, 132a, and 133a and the third electrode layer 134a of the sustain electrodes 130 may be formed of, for example, black metal oxide, and the widths W₁ and W₃ of the first electrode layers 131a, 132a, and 133a and the third electrode layer 134a, respectively, may be greater than the widths W₂ and W₄ of the second electrode layers 131b, 132b, and 133b and the fourth electrode layer 134b, respectively. In this regard, the cost of manufacturing may be reduced while improving the bright room contrast of an image.

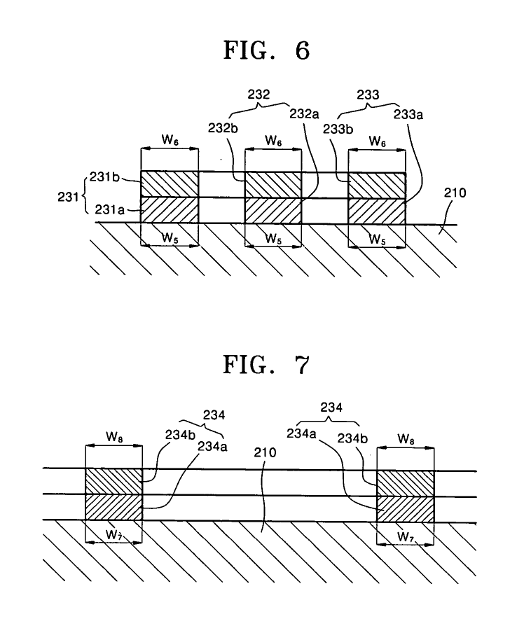

FIG. 6 illustrates a cross-sectional view of first electrode layers 231a, 232a, 233a and second electrode layers 231b, 232b, and 233b of a modified PDP according to an exemplary embodiment of the present invention. FIG. 7 illustrates a cross-sectional view of a third electrode layer 234a and a fourth electrode layer 234b of the modified PDP according to an exemplary embodiment of the present invention.

Referring to FIGS. 6 and 7, the modified PDP will now be described compared to the PDP 100 illustrated in FIG. 1. FIGS. 6 and 7 illustrating main electrode portions 231, 232, 233 and a connection electrode portion 234 correspond to FIGS. 3 and 4, respectively.

The sustain electrodes of the modified PDP include the main electrode portions 231, 232, 233 and the connection electrode portion 234. Widths W₅ of the first electrode layers 231a, 232a, 233a may be equal to widths W₆ of the second electrode layers 231b, 232b, and 233b. Also a width W₇ of the third electrode layer 234a of the connection electrode portion 234 may be the same as a width W₈ of the fourth electrode layer 234b.

Similar to that already discussed above, materials such as Ag, PbO, binder resin, etc. and black materials may be mixed to form a paste, and thus the first electrode layers 231a, 232a, 233a, and the third electrode layer 234a may be formed by disposing the paste on a first substrate 210, and have conductive properties.

The second electrode layers 231b, 232b, and 233b, and the fourth electrode layer 234b may be disposed on the first electrode layers 231a, 232a, 233a, and the third electrode layer 234a, respectively, formed of materials such as Ag, PbO, binder resin, etc., and may have conductive properties, as previously discussed above.

The first electrode layers 131a, 132a, 133a, and the third electrode layer 134a of the PDP 100 may be formed of non-conductive materials, whereas, the first electrode layers 231a, 232a, 233a, and the third electrode layer 234a of the modified PDP may be formed of conductive materials, so that electric current may flow in the first electrode layers 231a, 232a, 233a, and the third electrode layer 234a, and the second electrode layers 231b, 232b, and 233b, and the fourth electrode layer 234b. Therefore, the modified PDP may include sustain electrodes with reduced resistance so that a constant discharge may occur in the sustain electrodes and discharge efficiency may be increased.

The first electrode layers 231a, 232a, 233a, and the third electrode layer 234a may absorb most of the visible external light. Hence, the reflection of the visible light may be greatly reduced, which may improve a bright room contrast of an image displayed by the modified PDP.

The first electrode layers 231a, 232a, 233a, the second electrode layers 231b, 232b, 233b, the third electrode layer 234a, and the fourth electrode layer 234b illustrated in FIGS. 6 and 7 may be included in the sustain electrode. Likewise, main electrode portions and a connection electrode of another sustain electrode (not illustrated) may also include first, second, third, and fourth electrode layers.

In the modified PDP, the sustain electrodes may not be formed of ITO. Rather, the first electrode layers 231a, 232a, and 233a and the third electrode layer 234a of the sustain electrodes may be formed of black metal oxide and conductive materials, and the widths W₅ of the first electrode layers 231a, 232a, and 233a may be the same as the widths W₆ of the second electrode layers 231b, 232b, and 233c, and the width W₇ of the third electrode layer 234a may be the same as the width W₈ of the fourth electrode layers 234b. In this regard, the cost of manufacturing may be reduced while improving the bright room contrast of an image and increasing discharge efficiency.

The structure, operation, and effect of the modified PDP may be the same as the PDP 100 and therefore, descriptions thereof have been omitted.

A PDP of the present invention may not use sustain electrodes formed of ITO, which may simplify a manufacturing process, may minimize short circuits of discharge electrodes during the manufacturing process, and may greatly reduce manufacturing costs.

According to the present invention, sustain electrodes may be formed of two electrode layers in which first and third electrode layers with a high blackness may be tightly adhered to a first substrate, widths of the first electrode layers may be greater than or equal to those of second electrode layers, widths of the third electrode layers may be greater than or equal to those of fourth electrode layers, so that the sustain electrodes may reduce a reflection ratio of external light, which may improve a bright room contrast.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate;
a second substrate parallel to the first substrate;
a plurality of sustain electrodes disposed on the first substrate, each sustain electrode including a plurality of main electrode portions;
a first dielectric layer covering the sustain electrodes;
barrier ribs interposed between the first and the second substrates and partitioning discharge cells along with the sustain electrodes;
address electrodes disposed on the second substrate and crossing the sustain electrodes;
a second dielectric layer covering the address electrodes;
luminescent layers disposed in the discharge cells; and
a discharge gas in the discharge cells,
wherein the main electrode portions include first electrode layers adhered to the first substrate and second electrode layers adhered to the first electrode layers, the second electrode layers having widths less than or equal to widths of the first electrode layers.

2. The PDP as claimed in claim 1, wherein the main electrode portions are substantially parallel to one another.

3. The PDP as claimed in claim 1, wherein the sustain electrodes further include a connection electrode portion which connects the main electrode portions.

4. The PDP as claimed in claim 3, wherein the connection electrode portion perpendicularly intersects the main electrode portions.

5. The PDP as claimed in claim 3, wherein the connection electrode portion includes a plurality of connection electrode portions.

6. The PDP as claimed in claim 3, wherein each of the discharge cells includes at least two connection electrode portions.

7. The PDP as claimed in claim 1, wherein the sustain electrodes further include connection electrode portions which connect the main electrode portions, wherein the connection electrode portions include a third electrode layer adhered to the first substrate and a fourth electrode layer adhered to the third electrode layer, the fourth electrode layer having a width less than or equal to a width of the third electrode layer.

8. The PDP as claimed in claim 7, wherein the third electrode layer is formed of a metal oxide.

9. The PDP as claimed in claim 8, wherein the metal oxide has a color for absorbing light.

10. The PDP as claimed in claim 9, wherein metal oxide is black.

11. The PDP as claimed in claim 7, wherein the fourth electrode layer is formed of a conductive metal including silver (Ag) or aluminum (Al).

12. The PDP as claimed in claim 1, wherein each of the sustain electrodes include a common electrode and a scan electrode disposed parallel to each other.

13. The PDP as claimed in claim 1, wherein the barrier ribs are formed of dielectric materials.

14. The PDP as claimed in claim 1, wherein at least a portion of the first dielectric layer is covered by a protective layer.

15. The PDP as claimed in claim 1, wherein the first electrode layers are formed of a metal oxide.

16. The PDP as claimed in claim 15, wherein the metal oxide has a color for absorbing light.

17. The PDP as claimed in claim 16, wherein the metal oxide is black.

18. The PDP as claimed in claim 1, wherein the second electrode layer is formed of a conductive metal including silver (Ag) or aluminum (Al).

19. A plasma display panel, comprising:
a first substrate and a second substrate;
a plurality of sustain electrodes disposed on the first substrate, wherein each sustain electrode includes a plurality of main electrode portions; and
barrier ribs arranged between the first and second substrates to define a plurality of discharge cells,
wherein each main electrode portion includes first electrode layers and second electrode layers, the second electrode layers having widths less than or equal to widths of the first electrode layers, and the sustain electrodes are made of a black metal oxide.

20. A plasma display panel, comprising:
a first substrate and a second substrate;
a plurality of sustain electrodes disposed on the first substrate,
wherein each sustain electrode includes a plurality of main electrode portions and connection electrode portions that connect the main electrode portions; and
barrier ribs arranged between the first and second substrates to define a plurality of discharge cells,
wherein each main electrode portion includes first electrode layers and second electrode layers, the second electrode layers having widths less than or equal to widths of the first electrode layers, and the sustain electrodes are made of a black metal oxide.
